(19) United States
(12) Patent Application Publication
(10) Pub. No.: US 2012/0028868 A1
(43) Pub. Date: Feb. 2, 2012

(54) REMOVAL OF METAL SALT-COMPRISING IONIC LIQUIDS FROM WORKPIECES AND RECYCLING OF SUCH LIQUIDS

(75) Inventors: Aurelie Alemany, Stuttgart (DE); Itamar Michael Malkowsky, Hassloch (DE)

(73) Assignee: BASF SE, Ludwigshafen (DE)

(21) Appl. No.: 13/264,455

(22) PCT Filed: Apr. 13, 2010
(86) PCT No.: PCT/EP2010/054787

§ 371 Date: Oct. 14, 2011

(30) Foreign Application Priority Data
Apr. 16, 2009 (EP) 09158004.3

(51) Int. Cl. C11D 7/50; C11D 7/32; C11D 7/00

(52) U.S. Cl. 510/109

(57) ABSTRACT

The present invention relates to a method of removing residues of a metal salt comprising ionic liquid—from a workpiece, which comprises the step
(a) treatment of at least part of the workpiece surface with a treatment agent comprising a metal salt ionic liquid-free and/or an organic solvent which is an optionally halogenated hydrocarbon or a mixture of two or more of such hydrocarbons.

The present invention relates to a method of removing residues of an ionic liquid comprising metal salts from a workpiece.

Ionic liquids are known in the prior art. They are salts but have a melting point at comparatively low temperatures, usually less than 200° C., mostly less than 150° C. and in particular less than 100° C. They are used, for example, in the electrodeposition of metals but also in electrolytic deposition as electrolyte or as solvent.

U.S. Pat. No. 6,881,321 describes, for example, the electrodeposition of metals with the aid of an ionic liquid.

Specifically the electrodeposition of aluminum on magnesium alloys in aluminum chloride/1-ethyl-3-methylimidazolium chloride as ionic liquid is described by J.-K. Chang et al., Electrochemistry Communications 9 (2007), 1602-1606.

Methods of cleaning aluminum electrochemically with the aid of ionic liquids are known from WO-A 2009/007 440.

After carrying out the electrodeposition, the workpiece is, in the abovementioned prior art, washed with water or solvents such as methanol or acetonitrile in order to remove adhering ionic liquid. This typically comprises aluminum chloride as metal salt, since the aduct formed therefrom with the ionic liquid has been found to be particularly advantageous in electrolytic or electrochemical deposition.

However, the abovementioned liquids are disadvantageous since they lead to washing out of the metal salt component from the ionic liquid, so that the ionic liquid becomes depleted of the salt. Recycling of the ionic liquid is therefore adversely affected. Furthermore, the metal salt in the ionic liquid can hydrolyze, which may result in liberation of corrosive vapors such as hydrogen chloride gases.

Finally, corrosion of the workpiece can also occur.

There is therefore a need for suitable liquids for removing metal salt-comprising ionic liquids which adhere to surfaces of workpieces, in particular after the workpieces have been subjected to electrochemical or electrolytic deposition.

It is therefore an object of the present invention to provide alternative methods for removing residues of a metal salt comprising ionic liquid-, which do not have at least some of the abovementioned disadvantages.

The object is achieved by a method of removing residues of a metal salt—comprising ionic liquid from a workpiece, which comprises the step
(a) treatment of at least part of the workpiece surface with a treatment agent comprising a metal salt ionic liquid-free and/or an organic solvent which is an optionally halogenated hydrocarbon or a mixture of two or more of such hydrocarbons.

It has been found that treatment of at least part of the surface of the workpiece makes it possible to remove the residues while at least partly avoiding the abovementioned disadvantages, wherein the treatment agent is a metal salt ionic liquid-free. Furthermore, the treatment agent can be an optionally halogenated hydrocarbon or a mixture of two or more such hydrocarbons. It is also possible to use both treatment agents simultaneously or successively in the treatment. The treatment agent can comprise the metal salt ionic liquid-free and/or the organic solvent or consist of one or both liquids.

Ionic liquids are known in the prior art. They are described, for example, in DE-A 10 2005 017 733.

Preferred ionic liquids comprise at least one organic compound as cation and very particularly preferably comprise exclusively organic compounds as cations.

Suitable organic cations are, in particular, organic compounds having heteroatoms such as nitrogen, sulfur or phosphorus, particularly preferably organic compounds having a cationic group selected from among an ammonium group, an oxonium group, a sulfonium group and a phosphonium group.

In one particular embodiment, the ionic liquids are salts having ammonium cations, which for the present purposes are compounds having a localized positive charge on the nitrogen atom, e.g. in the case of tetravalent nitrogen or trivalent nitrogen having a double bond in non-aromatic ring systems, or aromatic compounds having a delocalized positive charge and at least one nitrogen atom, preferably one or two nitrogen atoms, in the ring system.

Particularly preferred organic cations comprise a five- or six-membered heterocyclic ring system having one or two nitrogen atoms as constituent(s) of the ring system.

Possible cations are, for example, pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations and imidazolidinium. These cations are described, for example, in WO 2005/113702.

Preference is therefore given to the metal salt comprising ionic liquid and/or the metal salt ionic liquid-free comprising at least one cation selected from the group of cations consisting of pyridinium cations, pyridazinium cations, pyrimidinium cations, pyrazinium cations, imidazolium cations, pyrazolium cations, pyrazolinium cations, imidazolinium cations, thiazolium cations, triazolium cations, pyrrolidinium cations and imidazolidinium cations.

Insofar as it is necessary in order to obtain a positive charge on the nitrogen atom or in the aromatic ring system, the nitrogen atoms are substituted by an organic group having generally not more than 20 carbon atoms, preferably a hydrocarbon group, in particular a C1-C16-alkyl group, in particular a C1-C10-alkyl group, particularly preferably a C1-C4-alkyl group.

The carbon atoms of the ring system can also be substituted by organic groups having generally not more than 20 carbon atoms, preferably a hydrocarbon group, in particular a C1-C16-alkyl group, in particular a C1-C10-alkyl group, particularly preferably a 1-C4-alkyl group.

Particularly preferred ammonium cations are imidazolium cations, pyrimidinium cations and pyrazolium cations, which for the present purposes are all compounds having an imidazolium, pyridinium or pyrazolium ring system and optionally any substituents on the carbon and/or nitrogen atoms of the ring system.

Very particular preference is given to an imidazolium cation.

In a particular embodiment, the ionic liquids are imidazolium compounds, particularly preferably imidazolium compounds of the formula

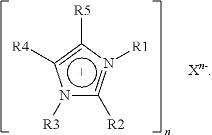

where
R1 and R3 are each, independently of one another, an organic radical having from 1 to 20 carbon atoms,
R2, R4, and R5 are each, independently of one another, an H atom or an organic radical having from 1 to 20 carbon atoms,
X is an anion and
n is 1, 2 or 3.

Preference is given to R1 and R3 each being, independently of one another, an organic group comprising from 1 to 10 carbon atoms. Particular preference is given to a hydrocarbon group which has no further heteroatoms, e.g. a saturated or unsaturated aliphatic group, an aromatic group or a hydrocarbon group which has both aromatic and aliphatic parts. Very particular preference is given to a C1-C10-alkyl group, a C1-C10-alkenyl group, e.g. an allyl group, a phenyl group, a benzyl group. In particular the group is a C1-C4-alkyl group, e.g. a methyl group, ethyl group, propyl group, i-propyl group or n-butyl group.

Preference is given to R2, R4 and R5 each being, independently of one another, an H atom or an organic group comprising from 1 to 10 carbon atoms. R2, R4 and R5 are particularly preferably an H atom or a hydrocarbon group having no further heteroatoms, e.g. an aliphatic group, an aromatic group or a hydrocarbon group having both aromatic and aliphatic parts. Very particular preference is given to an H atom or a C1-C10-alkyl group, a phenyl group or a benzyl group. In particular, the radicals are an H atom or a C1-C4-alkyl group, e.g. a methyl group, ethyl group, propyl group, i-propyl group or n-butyl group.

The variable n is preferably 1.

The anion can be an organic or inorganic anion. Particularly preferred ionic liquids consist exclusively of the salt of an organic cation with one of the anions mentioned below. As anions, it is in principle possible to use all anions which in combination with the cation lead to an ionic liquid.

The anion of the ionic liquid is, for example, selected from
the group of halides and halogen-comprising compounds of the formulae:

F⁻, Cl⁻, Br⁻, I⁻, BF₄⁻, PF₆⁻, BCL₄⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:

SO₄²⁻, HSO₄⁻, SO₃²⁻, HSO₃⁻, R^{a}OSO₃⁻, R^{a}SO₃
the group of phosphates of the general formulae:

PO₄³⁻, HPO₄²⁻, H₂PO₄⁻, R^{a PO}₄²⁻, HR^{a}PO₄⁻, R^{a}R^{b}PO₄⁻
the group of phosphonates and phosphinates of the general formulae:

R^{a}HPO₃⁻, R^{a}R^{b}PO₂⁻, R^{a}R^{b}PO₃⁻
the group of phosphites of the general formulae:

PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:

R^{a}R^{b}PO₂⁻, R^{a}HPO₂⁻, R^{a}R^{b}PO⁻, R^{a}HPO⁻
the group of carboxylic acids of the general formula:

R^{a}COO⁻
the group of borates of the general formulae:

BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:

R^{a}BO₂²⁻, R^{a}R^{b}BO⁻
the group of carbonates and carbonic esters of the general formulae:

HCO₃⁻, CO₃²⁻R^{a}CO₃⁻
the group of silicates and silicic esters of the general formulae:

SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:

R^{a}SiO₃³⁻, R^{a}R^{b}SiO₂²⁻, R^{a}R^{b}R^{c}SiO₂²⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae:

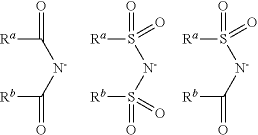

the group of methides of the general formula:

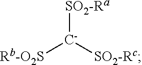

the group of alkoxides and aryloxides of the general formula:

R^{a}O⁻;
the group of sulfides, hydrogensulfides, polysulfides, hydrogenpolysulfides and thiolates of the general formulae:
S²⁻, HS⁻, [Sᵥ]²⁻, [HSᵥ]⁻, [R^{a}S]⁻,
where v is a positive integer from 2 to 10.

In these formulae, R^{a}, R^{b}, R^{c} and R^{d} are each, independently of one another, hydrogen, C₁-C₃₀-alkyl, C₂-C₁₈-alkyl, which is optionally interrupted by one or more non-adjacent oxygen and/or sulfur atoms and/or one or more substituted or unsubstituted imino groups, C₆-C₁₄-aryl, C₅-C₁₂-cycloalkyl or a five- or six-membered heterocycle having oxygen, nitrogen and/or sulfur atoms, where two of them can together form an unsaturated, saturated or aromatic ring which is optionally interrupted by one or more oxygen and/or sulfur atoms and/or one or more unsubstituted or substituted imino groups, where the radicals mentioned may each additionally be substituted by functional groups, aryl, alkyl, aryloxy, alkyloxy, halogen, heteroatoms and/or heterocycles.

Here, C₁-C₁₈-alkyl which is optionally substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorbenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylythioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which is optionally interrupted by one or more non-adjacent oxygen and/or sulfur atoms and/or one or more substituted or unsubstituted imino groups is, for example, 5-hydroxy-3-oxa pentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together be, for example as fused-on building block, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene

The number of non-adjacent oxygen and/or sulfur atoms and/or imino groups is in principle not subject to any restrictions or is restricted automatically by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between each two heteroatoms.

Substituted and unsubstituted imino groups can be, for example, imino, methylimino, iso-propylimino, n-butylimino or tert-butylimino.

The term “functional groups” refers, for example, to the following: carboxy, carboxamide, hydroxy, di(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which is optionally substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which is optionally substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered heterocycle having oxygen, nitrogen and/or sulfur atoms is, for example, furyl, thiophenyl, pyryl, pyridyl, indolyl, benzoxazolyl, dioxolyl, dioxyl, benzimidazolyl, benzthiazolyl, dimethylpyridyl, methylquinolyl, dimethylpyryl, methoxyfuryl, dimethoxypyridyl, difluoropyridyl, methylthiophenyl, isopropylthiophenyl or tert-butylthiophenyl.

Preferred anions are selected from the group of halides and halogen-comprising compounds, the group of carboxylic acids, the group of sulfates, sulfites and sulfonates and also the group of phosphates.

Preferred anions are chloride, bromide, iodide, SCN⁻, OCN⁻, CN⁻, acetate, C₁-C₄ alkylsulfate, R^{a}—COO⁻, R^{a}SO₃⁻, R^{a}R^{b}PO₄⁻, methanesulfonate, tosylate, C₁-C₄ dialkylphosphate or hydrogensulfate.

As cation, particular preference is given to using alkylimidazolium cations in which the two alkyl groups may be identical or difference, branched or unbranched, substituted by one or more phenyl groups or unsubstituted and have from one to six skeletal atoms.

Particular preference is given to benzylmethylimidazolium, hexylmethylimidazolium, butylmethylimidazolium, ethylmethylimidazolium.

Very particularly preferred anions are chloride; bromide; iodide; thiocyanate; hexafluorophosphate; trifluoromethanesulfonate; methanesulfonate; formate; acetate; mandelate; nitrate; nitrite; trifluoroacetate; sulfate; hydrogensulfate; methylsulfate; ethylsulfate; 1-propylsulfate; 1-butylsulfate; 1-hexylsulfate; 1-octylsulfate; phosphate; dihydrogenphosphate; hydrogenphosphate; C₁-C₄-dialkylphosphates; propionate; chlorozincate; chloroferrate; bis(trifluoromethylsulfonyl)imide; bis(pentafluoroethyl-sulfonyl)imide; bis(methylsulfonyl)imide; bis(p-tolylsulfonyl)imide; tris(trifluoromethyl-sulfonyl)methide; bis(pentafluoroethylsulfonyl)methide; p-toluenesulfonate; dimethylene glycol monomethyl ether sulfate; oleate; stearate; acrylate; methacrylate; maleate; hydrogencitrate; vinylphosphonate; bis(pentafluoroethyl)phosphinate; borates such as bis[salicylato(2-)]borate, bis[oxalato(2-)]borate, bis[1,2-benzenediolato(2-),-O,O′]borate, tetracyanoborate, tetrafluoroborate; dicyanamide; tris(pentafluoroethyl)trifluorophosphate; tris(heptafluoropropyl)trifluorophosphate, cyclic arylphosphates such as pyrocatecholphosphate (C₆H₄O₂)P(O)O⁻.

Very particularly preferred anions are

chloride, bromide, hydrogensulfate, thiocyanate, methylsulfate, ethylsulfate, methansulfonate, formate, acetate, dimethylphosphate, diethylphosphate, p-toluene-sulfonate, tetrafluoroborate and hexafluorophosphate.

Particular preference is given to ionic liquids comprising:
methyltri(1-butyl)ammonium, 2-hydroxyethylammonium, 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-di-methylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethyl-imidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-Tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butyl-imidazolium, 1-(1-hexadecyl)-3-octylimidazolium, 1,2-dimethylimidazolium, 1,2,3-tri-methylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium or 1,4,5-trimethyl-3-octylimidazolium

as cation and

chloride, bromide, hydrogensulfate, thiocyanate, methylsulfate, ethylsulfate, methansulfonate, formate, acetate, dimethylphosphate, diethylphosphate, p-toluene-sulfonate, tetrafluoroborate and hexafluorophosphate

as anion.

Furthermore, particular preference is given to the following ionic liquids:
1,3-dimethylimidazolium methylsulfate, 1,3-dimethylimidazolium hydrogensulfate, 1,3-dimethylimidazolium dimethylphosphate, 1,3 dimethylimidazolium acetate, 1-ethyl-3-methylimidazolium methylsulfate, 1-ethyl-3-methylimidazolium hydrogensulfate, 1-ethyl-3-methylimidazolium thiocyanate, 1-ethyl-3-methylimidazolium acetate, 1-ethyl-3-methylimidazolium methanesulfonate, 1-ethyl-3-methylimidazolium diethylphosphate, 1-(1-butyl)-3-methylimidazolium methylsulfate, 1-(1-butyl)-3-methylimidazolium hydrogensulfate, 1-(1-butyl)-3-methylimidazolium thiocyanate, 1-(1-butyl)-3-methylimidazolium acetate, 1-(1-butyl)-3-methylimidazolium methanesulfonate, 1-(1-dodecyl)-3-methylimidazolium methylsulfate, 1-(1-dodecyl)-3-methylimidazolium hydrogensulfate, 1-(1-tetradecyl)-3-methylimidazolium methylsulfate, 1-(1-tetradecyl)-3-methylimidazolium hydrogensulfate, 1-(1-hexadecyl)-3-methylimidazolium methylsulfate or 1-(1-hexadecyl)-3-methylimidazolium hydrogensulfate or 2-hydroxyethylammonium formate.

The metal salt is preferably a metal halide, in particular a chloride. Mention may here be made of, for example, the metals iron and aluminum, in particular aluminum. Particular preference is given to the metal salt being aluminum chloride.

With regard to the metal salt-comprising ionic liquid, particular preference is given to this having at least one anion which is chloride and with aluminum chloride as metal salt forms a tetrachloroaluminate and/or a heptachloroaluminate.

The metal salt-comprising ionic liquid very particularly preferably has a formula KaCl×AlCl₃, where Ka is an imidazolium cation selected from the group consisting of benzylmethylimidazolium, hexylmethylimidazolium, butylmethylimidazolium and ethylmethylimidazolium and x is from 1.4 to 1.7, in particular 1.5.

The metal salt-comprising ionic liquid and/or the metal salt-free ionic liquid preferably have a melting point of <200° C., more preferably <150° C. and in particular <100° C.

The ionic liquid preferably has a melting point of less than 70° C., particularly preferably less than 30° C. and very particularly preferably less than 0° C., at 1 bar.

In a particularly preferred embodiment, the ionic liquid is liquid under normal conditions (1 bar, 21° C.), i.e. at room temperature.

The molecular weight of the ionic liquid is preferably less than 2000 g/mol, particularly preferably less than 1500 g/mol, particularly preferably less than 1000 g/mol and very particularly preferably less than 750 g/mol; in a particular embodiment, the molecular weight is in the range from 100 to 750 g/mol or from 100 to 500 g/mol.

Furthermore, preference is given to the metal salt-comprising ionic liquid and the metal salt-free ionic liquid comprising the same cations. Particular mention may be made here of the abovementioned imidazolium kations.

The treatment of the at least one part of the workpiece surface with the treatment agent in step (a) of the method of the invention in order to remove residues can be carried out by methods known to a person skilled in the relevant art One possibility is to rinse the at least one part of the workpiece surface with the treatment agent. In addition or as an alternative, before or after rinsing, the at least one part of the workpiece surface can also be dipped into a bath comprising the treatment agent. The bath can also consist of the treatment agent. Accordingly, the term “comprising” also includes a bath which consists exclusively of the treatment agent.

The organic solvent can be appropriately selected in such a way that the above-mentioned advantageous properties in the removal of residues can be obtained. Here, the organic solvent is an optionally halogenated hydrocarbon or a mixture of two or more such hydrocarbons. Mention may be made by way of example of aliphatic hydrocarbons such as hexane, heptane, octane, nonane or decane. Furthermore, mention may be made of halogenated, in particular chlorinated, aliphatic hydrocarbons such as dichloromethane, chloroform or CCl₄. The organic solvent can also be an aromatic hydrocarbon such as benzene. Furthermore, the organic solvent can also be a hydrocarbon having both aliphatic and aromatic parts. Examples which may be mentioned here are toluene, ethylbenzene and xylene. Halogenated aromatic hydrocarbons and halogenated hydrocarbons having both an aliphatic part and an aromatic part can also be used. Examples which may be mentioned here are chlorobenzene, dichlorbenzene, xylene bromide and trichloromethylbenzene. The organic solvent is preferably heptane, toluene, xylene, chlorobenzene, dichlorobenzene, ethylbenzene or a mixture thereof. The organic solvents can thus be present in pure form or as a mixture comprising two, three or more such solvents.

Still preferred is a decalin and/or a paraffin. A decalin may be unsubstituted or mono- or multisubstituted, especially C₁ to C₄ alkyl substituted decalin or a derivative thereof. A paraffin may be a branched or unbranched, especially branched paraffin (isoparaffin), preferably >C₁₀ and in particular C₁₀ to C₂₄ paraffin.

Step (a) of the method of the invention can be followed by a further washing step or a plurality of further washing steps which can, in particular, passivate the surface after an electrodeposition operation. Here, it is also possible to use solvents which, owing to the ease with which they are decomposed, are unsuitable or disadvantageous for step (a). Mention may here be made of, for example, acetone and acetonitrile. However, alcohols can also be used in the subsequent washing step. Mention may here be made of methanol, ethanol and in particular isopropyl alcohol.

Furthermore, step (a) of the method of the invention is preferably carried out under the action of ultrasound. An ultrasonic treatment can also be carried out after step (a).

Step (a) of the method of the invention can be carried out at room temperature or at elevated temperature, for example at least 40° C., preferably at least 50° C., preferably at least 75° C., preferably at least 90° C. A metal salt-comprising ionic liquid is particularly advantageous at elevated temperature.

Furthermore, the residue of metal salt-comprising ionic liquid on the workpiece can originate from an electrolyte bath in the inventive method of removing residues. Here, it is conceivable, in particular, for the workpiece to have been subjected to an electrolytic or cathodic metal deposition process before removal of the residue.

The workpiece removed from metal salt comprising ionic liquid may be subject to further washing steps as outlined above. For example a washing with alcohol, like isopropanol, and/or water can be carried out. In particular an alcohol washing can serve as passivation of a metal deposited on the workpiece, wherein a subsequent water washing is advantageous.

Furthermore, the inventive method of removing residues can comprise the further method step
(b) separation of the metal salt-comprising ionic liquid comprised in the treatment agent after step (a) from the treatment agent.

For example, the separation can be effected by phase separation.

This makes it possible to reuse the metal salt-comprising ionic liquid.

The present invention therefore further provides a method comprising the further step
(c) transfer of the metal salt-comprising ionic liquid separated off in step (b) to an electrolyte bath.

This is particularly advantageous when the residue of the metal salt-comprising ionic liquid on the workpiece originates from an electrolyte bath and the residue is, in step (c), returned to the bath so that a recycling process is obtained. This recycling process can, if appropriate, be repeated one or more times using the same or different workpieces.

### EXAMPLES

### Example 1

### Toluene as Treatment Agent

An Al plate (70×20×5 mm³) is dipped into EMIMCl×1.5 AlCl₃ (EMIMCl=1-ethyl-3-methylimidazolium chloride) so that the surface of the plate is wetted completely. The plate is then dipped into toluene at 80° C. for 5 minutes, resulting in the adhering ionic liquid collecting in droplets on the plate. The plate is subsequently dipped into an acetone bath (2×5 min) and dried in air. Traces of the electrolyte are still visible on the plate.

### Example 2

### Heptane as Treatment Agent with Ultrasonic Treatment

An Al plate (70×20×5 mm³) is dipped into EMIMCl×1.5 AlCl₃ so that the surface of the plate is wetted completely. The plate is then dipped into heptane at room temperature for 5 minutes and treated with ultrasound, resulting in the adhering electrolyte collecting in droplets on the plate and gradually dropping to the bottom. The plate is subsequently dipped into an acetone bath (2×5 min) and dried in air. Only traces of the electrolyte are still visible on the plate.

### Example 3

### Chlorobenzene as Treatment Agent

An Al plate (70×20×5 mm³) is dipped into EMIMCl×1.5 AlCl₃ so that the surface of the plate is wetted completely. The plate is then dipped into chlorobenene at 80° C. for 5 minutes, resulting in part of the adhering electrolyte dissolving. The remainder of the electrolyte collects in droplets on the plate and gradually drops to the bottom. The plate is subsequently dipped into an acetone bath (2×5 min) and dried in air. Only traces of the electrolyte are still visible on the plate.

### Example 4

### Heptane as Treatment Agent

An Al plate (70×20×5 mm³) is dipped into EMIMCl×1.5 AlCl₃ so that the surface of the plate is wetted completely. The plate is then dipped in heptane at room temperature for 5 minutes, resulting in the adhering electrolyte collecting in droplets on the plate and gradually dropping to the bottom. The plate is subsequently dipped into an acetone bath (2×5 min) and dried in air. Electrolyte is no longer visible on the plate.

### Example 5

### EMIMCl and Heptane as Treatment Agent

An Al plate (70×20×5 mm³) is dipped into EMIMCl×1.5 AlCl₃ so that the surface of the plate is wetted completely. The plate is then dipped into EMIMCl at 90° C. for 5 minutes and subsequently into heptane at 70° C. for 5 minutes, resulting in the adhering EMIMCl collecting in droplets on the plate and gradually dropping to the bottom. The plate is subsequently dipped into an acetone bath (2×5 min) and dried in air. Electrolyte is no longer visible on the plate.

### Example 6

### Decalin as Treatment Agent

A steel plate (70×20×5 mm³) is galvanically coated with aluminium in a coating bath of EMIMCL×1.5 ALCL₃ as electrolyte. After coating the plate covered with aluminium is dipped into decalin for 5 min. at 80° C., resulting in the adhering electrolyte collecting in droplets on the plate and gradually dropping to the bottom. The plate is subsequently dipped into an iso-propanol bath (2×5 min.) to passivate the fresh Al layer, afterwards into a water bath (2×5 min.) and dried in air.

The lower phase of EMIMCL×1.5 ALCL₃ from the decalin washing bath is returned to the coating bath by phase separation and again used for Al deposition.

1-15. (canceled)

16. A method of removing a residue of a metal salt-comprising ionic liquid from a workpiece, the method comprising:
(a) treating at least part of a surface of the workpiece with a treatment agent comprising at least one selected from the group consisting of a metal salt-free ionic liquid and an organic solvent, wherein the organic solvent is an optionally halogenated hydrocarbon.

17. The method of claim 16, wherein at least one selected from the group consisting of the metal salt-comprising ionic liquid and the metal salt-free ionic liquid comprises at least one cation selected from the group consisting of a pyridinium cation, a pyridazinium cation, a pyrimidinium cation, a pyrazinium cation, an imidazolium cation, a pyrazolium cation, a pyrazolinium cation, an imidazolinium cation, a thiazolium cation, a triazolium cation, a pyrrolidinium cation, and an imidazolidinium cation.

18. The method of claim 16, wherein the metal salt is a metal halide.

19. The method of claim 16, wherein the metal salt is aluminum chloride.

20. The method of claim 16, wherein the metal salt-comprising ionic liquid comprises at least one anion which is chloride, and
wherein the metal salt-comprising ionic liquid forms at least one selected from the group consisting of a tetrachloroaluminate and a heptachlorodialuminate, with aluminum chloride as metal salt.

21. The method of claim 16, wherein the metal salt-comprising ionic liquid and the metal salt-free ionic liquid comprise the same cations.

22. The method of claim 16, wherein the treating is effected by rinsing the surface with the treatment agent.

23. The method of claim 16, wherein the treating is carried out by dipping the workpiece into a bath comprising the treatment agent.

24. The method of claim 16, wherein the organic solvent is present and comprises heptane, toluene, xylene, chlorobenzene, dichlorobenzene, ethylbenzene, a decalin, a paraffin, or a mixture thereof.

25. The method of claim 16, wherein the residue of metal salt-comprising ionic liquid on the workpiece originates from an electrolyte bath.

26. The method of claim 16, wherein the workpiece has been subjected to an electrolytic or cathodic metal deposition process before removal of the residue.

27. The method of claim 16, further comprising
(b) separating the metal salt-comprising ionic liquid comprised in the treatment agent after the treating (a) from the treatment agent.

28. The method of claim 27, wherein the separating is effected by phase separation.

29. The method of claim 27, further comprising
(c) transferring the metal salt-comprising ionic liquid separated off in the separating (b) to an electrolyte bath.

30. The method of claim 29, wherein the residue originates from an electrolyte bath and is recirculated in the transferring (c) to the bath, and optionally repeating recirculation.

31. The method of claim 17, wherein the metal salt is a metal halide.

32. The method of claim 17, wherein the metal salt is aluminum chloride.

33. The method of claim 18, wherein the metal salt is aluminum chloride.

34. The method of claim 17, wherein the metal salt-comprising ionic liquid comprises at least one anion which is chloride, and
wherein the metal salt-comprising ionic liquid forms at least one selected from the group consisting of a tetrachloroaluminate and a heptachlorodialuminate, with aluminum chloride as metal salt.

35. The method of claim 18, wherein the metal salt-comprising ionic liquid comprises at least one anion which is chloride, and
wherein the metal salt-comprising ionic liquid forms at least one selected from the group consisting of a tetrachloroaluminate and a heptachlorodialuminate, with aluminum chloride as metal salt.
